(19) United States
(12) Patent Application Publication
(10) Pub. No.: US 2015/0236755 A1
(43) Pub. Date: Aug. 20, 2015

(54) MEASURING DEVICE HAVING DATA TRANSMISSION FUNCTION

(71) Applicant: MITUTOYO CORPORATION, Kanagawa (JP)

(72) Inventors: Yoshitaka KUJI, Kanagawa (JP); Nobuyuki HAYASHI, Kawasaki (JP)

(73) Assignee: MITUTOYO CORPORATION, Kanagawa (JP)

(21) Appl. No.: 14/618,225

(22) Filed: Feb. 10, 2015

(30) Foreign Application Priority Data
Feb. 14, 2014 (JP) 2014-026260

(51) Int. Cl. H04B 5/00

(52) U.S. Cl. CPC H04B 5/0025

(57) ABSTRACT

A digital caliper includes a tag, a memory, and a trigger generator. An external device includes a reader reading data stored in the tag when the tag is held up to the reader. The memory stores at least one measured value measured by the digital caliper. The trigger generator generates a trigger for when a measured value measured by the digital caliper is to be stored in the memory. The tag transmits to the external device all measured values stored in the memory based on the trigger generated by the trigger generator when the tag is held up to the reader of the external device.

### CROSS-REFERENCE TO RELATED APPLICATIONS

The present application claims priority under 35 U.S.C. §119 of Japanese Application No. 2014-026260, filed on Feb. 14, 2014, the disclosure of which is expressly incorporated by reference herein in its entirety.

### BACKGROUND OF THE INVENTION

1. Field of the Invention

The present invention relates to a measuring device, and particularly relates to a measuring device transmitting data to an external device.

2. Description of Related Art

Conventional examples of a measuring device transmitting data to an external device are known. For example, a measuring device described in Japanese Patent Laid-open Publication No. 2003-256974 includes a connector cable connecting the measuring device and an external device. The measuring device transmits instrument data to the external device via the connector cable. In addition, a measurement system described in Japanese Patent Laid-open Publication No. 2009-033422 includes a child transceiver wirelessly transmitting measurement data by being connected to a measuring device, and a parent transceiver receiving the measurement data sent by the child transceiver and transmitting the data to a computer (external device). The measuring device transmits measurement data to the computer via each of the transceivers.

However, the measuring device described in Japanese Patent Laid-open Publication No. 2003-256974 includes the connector cable connecting the measuring device and the external device. Therefore, in a case where the invention is applied to a measuring device that a user holds in the hand to perform measurement, such as a digital caliper or a micrometer, moving the measuring device during measurement may become difficult and performing the measurement may in fact be made more difficult. Further, in order for the measuring device described in Japanese Patent Laid-open Publication No. 2009-033422 to wirelessly transmit the measurement data, a battery is mounted to the child transceiver. Therefore, the size or weight of the measuring device may increase.

### SUMMARY OF THE INVENTION

The present invention provides a measuring device capable of transmitting data to an external device without negatively impacting user-friendliness.

A measuring device according to an aspect of the present invention includes a data transmitter transmitting data to an external device using near field communication.

Herein, “near field communication” refers to contact-less communication performed at extremely short distances, between a few cm and 1 m, and can be exemplified by RFID (Radio Frequency IDentification) technology. RFID is a technology in which data stored in an IC (integrated circuit) called a tag can be read by a reader by holding the tag up to the reader. Moreover, there are various kinds of tags, and of these a tag referred to as a passive tag does not require that a battery be installed because radio waves from the reader act as an energy source. In addition, data is not limited to a measured value measured by the measuring device, and may refer to all data relating to the measuring device, such as a production number of the measuring device, data for an inspection at the time of shipping the measuring device, and the like.

According to an aspect of the present invention, the data transmitter transmits data to the external device using near field communication. Therefore, data can be transmitted to the external device without negatively impacting user-friendliness of the measuring device. Specifically, near field communication is contact-less communication performed at extremely short distances; therefore, there is no need for a cable and even in a case where the invention is applied to a measuring device that a user holds in the hand to perform measurement, such as a digital caliper or a micrometer, the measuring device will not become difficult to move during measurement. In addition, in a case where the data transmitter is configured so as to operate with radio waves from the external device as an energy source, as with a passive tag, there is no need to install a battery and the size and weight of the measuring device do not increase.

In an aspect of the present invention, a measuring device includes a controller having a data transmitter. The controller includes a memory storing at least one measured value measured by the measuring device; and a trigger generator generating a trigger for when the measured value measured by the measuring device is to be stored in the memory. The data transmitter transmits to the external device the measured value stored in the memory based on the trigger.

Herein, in a case where the data is transmitted to the external device using near field communication, after a measurement is taken using the measuring device, the measuring device and the external device must be brought close to each other. Therefore, in the case where the invention is applied to the measuring device that the user holds in the hand to perform measurement, such as a digital caliper or a micrometer, the measured value may change due to an influence of shaking hands or the like when bringing the measuring device and the external device close to each other. According to an aspect of the present invention, the data transmitter transmits to the external device a measured value stored in the memory based on the trigger for when the measured value measured by the measuring device is to be stored in the memory. Therefore, the measured value does not change when the measuring device and the external device approach each other. Accordingly, data can be transmitted to the external device without negatively impacting user-friendliness of the measuring device.

In an aspect of the present invention, the measuring device includes a button provided so as to be exposed to an exterior, and the trigger generator generates a trigger due to a user operating the button.

According to this configuration, the trigger generator generates a trigger due to the user operating the button. Therefore, the user can store a measured value in the memory at a desired point in time. Accordingly, data can be transmitted to the external device without negatively impacting user-friendliness of the measuring device.

In an aspect of the present invention, the controller includes a voice inputter which receives voice input, and the trigger generator generates a trigger due to the voice inputter receiving the voice input.

According to this configuration, the trigger generator generates a trigger due to the voice inputter receiving a voice input. Therefore, the user can store a measured value in the memory at a desired point in time without touching the measuring device. Accordingly, data can be transmitted to the external device without negatively impacting user-friendliness of the measuring device.

In an aspect of the present invention, the controller includes a measured value monitor which monitors fluctuations in a measured value over a predetermined interval, and the trigger generator generates a trigger due to an absence of fluctuation in the measured value observed by the measured value monitor during the predetermined period of time.

According to this configuration, the trigger generator generates a trigger due to an absence of fluctuation in the measured value observed by the measured value monitor during a predetermined period of time. Therefore, the user can store a measured value in the memory simply by performing a normal measurement operation. Accordingly, data can be transmitted to the external device without negatively impacting user-friendliness of the measuring device. “An absence of fluctuation in the measured value during a predetermined period of time” refers to fluctuations in the measured value being continuously kept within a fixed range until a predetermined period of time elapses.

In an aspect of the present invention, the controller includes a time measurer measuring an amount of time, and the trigger generator generates a trigger for each predetermined amount of time elapsed.

According to this configuration, the trigger generator generates a trigger for each predetermined amount of time elapsed. Therefore, the user can store a measured value in the memory automatically simply by performing measurement. Accordingly, data can be transmitted to the external device without negatively impacting user-friendliness of the measuring device.

In an aspect of the present invention, the data transmitter is provided to an interior of the measuring device.

According to this configuration, the data transmitter is provided to the interior of the measuring device. Therefore, damage or dropping of the data transmitter can be inhibited as compared to a case where the data transmitter is provided to an exterior of the measuring device.

In an aspect of the present invention, the data transmitter transmits data to the external device when in a state capable of transmitting data to the external device.

According to this configuration, the data transmitter transmits data to the external device when in a state capable of transmitting data to the external device. Therefore, data can be transmitted to the external device without negatively impacting user-friendliness of the measuring device.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1A is a front view and FIG. 1B is a back view of a digital caliper according to a first embodiment of the present invention;

FIG. 2 is a schematic, cross-sectional view of a slider;

FIG. 3 is a block diagram illustrating the digital caliper and an external device;

FIG. 4 is a block diagram illustrating a digital caliper and an external device according to a second embodiment of the present invention;

FIG. 5 is a block diagram illustrating a digital caliper and an external device according to a third embodiment of the present invention;

FIG. 6 is a block diagram illustrating a digital caliper and an external device according to a fourth embodiment of the present invention;

FIG. 7 is a block diagram illustrating a digital caliper and an external device according to a fifth embodiment of the present invention;

FIG. 8 illustrates a first exemplary tag mounting position; and

FIG. 9 illustrates a second exemplary tag mounting position.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

### First Embodiment

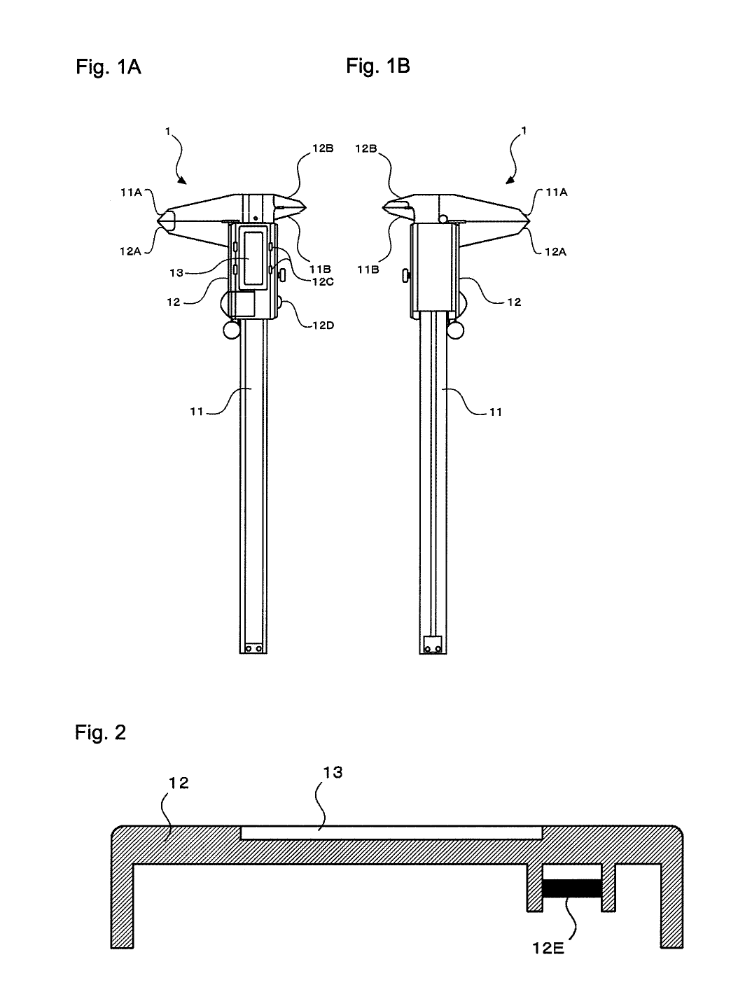

Hereafter, a first embodiment of the present invention is described with reference to the drawings. FIG. 1A is a front view and FIG. 1B is a back view of a digital caliper according to the first embodiment of the present invention. As shown in FIGS. 1A and 1B, a digital caliper 1 is a measuring device that includes a main scale 11 formed in a rectangular plate shape and a squared tube-shaped slider 12 attached to the main scale 11 so as to be capable of sliding along a length direction thereof.

The main scale 11 includes an exterior measurement jaw 11A (left side in FIG. 1A) provided on a slider 12-side end in the length direction, and an interior measurement jaw 11B (right side in FIG. 1A) provided on an opposite side from the exterior measurement jaw 11A. In addition, main scale marks (not shown in the drawings) are provided to a front surface of the main scale 11.

The slider 12 includes an exterior measurement jaw 12A provided so as to correspond to the exterior measurement jaw 11A, and an interior measurement jaw 12B provided so as to correspond to the interior measurement jaw 11B. The slider 12 also includes a display 13 provided on a front surface; a plurality of mechanical switches 12C provided around the display 13; and a button 12D provided to a right lateral surface of the slider 12 so as to be exposed to an exterior of the digital caliper 1. The display 13 displays data using a liquid crystal display.

The digital caliper 1 is capable of measuring an exterior length of a measured object by sliding the slider 12 relative to the main scale 11 and bringing the exterior measurement jaws 11A and 12A into contact with the exterior of the measured object. In addition, the digital caliper 1 is capable of measuring an interior length of the measured object by bringing the interior measurement jaws 11B and 12B into contact with the interior of the measured object. Also, the digital caliper 1 displays data on the display 13, such as a measured value obtained by measuring the measured object.

FIG. 2 schematically illustrates a cross-section of a slider. Specifically, FIG. 2 schematically illustrates a cross-section of the slider 12 sectioned along a left-right direction of FIG. 1. As shown in FIG. 2, the slider 12 includes a tag 12E mounted to a rear side of the surface to which the display 13 is provided, i.e., between the main scale 11 and the display 13. In other words, the tag 12E is provided on an interior of the digital caliper 1. The tag 12E is a passive RFID tag, as noted above, and data stored in the tag 12E can be read by a reader (described hereafter) by holding the tag 12E up to the reader. Moreover, the tag 12E does not require that a battery be installed because radio waves from the reader act as an energy source.

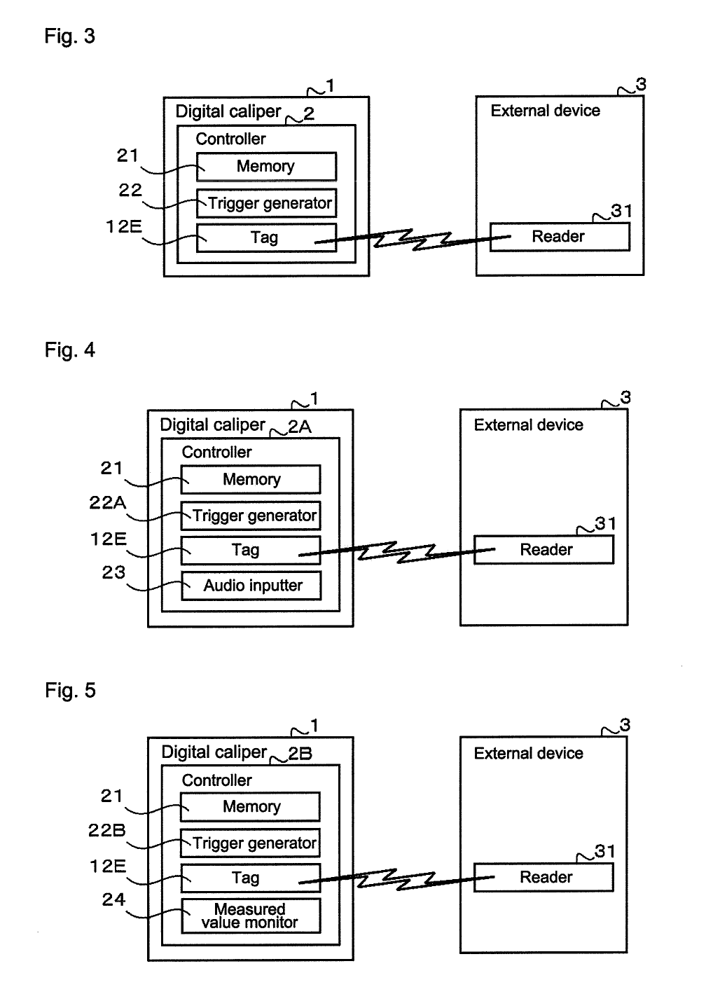

FIG. 3 is a block diagram illustrating the digital caliper and an external device. As shown in FIG. 3, the digital caliper 1 is configured by a CPU (Central Processing Unit) and the like, and also includes a controller 2 which executes data processing according to a predetermined program. The controller 2 also includes a memory 21, in addition to the tag 12E described above, storing a program, data, or the like; and a trigger generator 22 generating a trigger for when the measured value measured by the digital caliper 1 is to be stored in the memory 21. An external device 3 includes a reader 31 reading the data stored on the tag 12E when the tag 12E is held up to the reader 31. A PC (Personal Computer) can be employed as the external device 3, for example.

The memory 21 stores at least one measured value measured by the digital caliper 1. The trigger generator 22 generates a trigger due to a user manipulating the button 12D on the slider 12. Accordingly, the user of the digital caliper 1 can cause a measured value to be stored in the memory 21 when the button 12D is depressed during measurement of the measured object by the digital caliper 1.

By holding the tag 12E up to the reader 31 of the external device 3, all measured values stored in the memory 21 based on the trigger generated by the trigger generator 22 are transmitted to the external device 3. Specifically, the tag 12E is a data transmitter transmitting data to the external device 3 using near field communication. Accordingly, after measurement is complete for all locations on the measured object to be measured using the digital caliper 1, the user of the digital caliper 1 can transmit all measured values to the external device 3 by bringing the slider 12 close to the reader 31 of the external device 3.

In this way, the following effects and advantages can be achieved according to the present embodiment: (1) Using near field communication, the tag 12E transmits data to the external device 3. Therefore, data can be transmitted to the external device 3 without negatively impacting user-friendliness of the digital caliper 1. Specifically, near field communication is contact-less communication performed at extremely short distances; therefore, there is no need for cables and the digital caliper 1 will not become difficult to move during measurement. In addition, the tag 12E does not require the installation of a battery, and thus neither the size nor the weight of the digital caliper 1 is increased.

(2) The tag 12E transmits to the external device 3 a measured value stored in the memory 21 based on the trigger for when the measured value measured by the digital caliper 1 is to be stored in the memory 21. Therefore, the measured value does not change when the digital caliper 1 and the external device 3 approach each other. Accordingly, data can be transmitted to the external device 3 without negatively impacting user-friendliness of the digital caliper 1. (3) The trigger generator 22 generates a trigger due to the user manipulating the button 12D. Therefore, the user can store a measured value in the memory 21 at a desired point in time. Accordingly, data can be transmitted to the external device 3 without negatively impacting user-friendliness of the digital caliper 1. (4) The tag 12E is provided to the interior of the digital caliper 1. Therefore, damage or dropping of the tag 12E can be inhibited as compared to a case where the tag 12E is provided to the exterior of the digital caliper 1.

### Second Embodiment

Hereafter, a second embodiment of the present invention is described with reference to the drawings. In the following description, those portions which have been previously described are assigned identical reference numerals and a description thereof is omitted. FIG. 4 is a block diagram illustrating a digital caliper and an external device according to the second embodiment of the present invention. In the first embodiment, the slider 12 includes the button 12D, and the trigger generator 22 generates a trigger due to the user manipulating the button 12D. In contrast, in the present embodiment, a controller 2A includes a voice inputter 23 which receives voice input, and a trigger generator 22A differs in that a trigger is generated due to the voice inputter 23 receiving the voice input.

Specifically, the voice inputter 23 determines whether a predetermined voice input has been received via a microphone (not shown in the drawings) provided to the slider 12. For example, the voice inputter 23 can be configured so as to recognize a predetermined word (for example, “start” or “measure”) spoken by the user of the digital caliper 1. In the present embodiment, the voice inputter 23 is configured so as to recognize the predetermined word; however, the voice inputter 23 may also be configured so as to recognize a loud noise, for example. In essence, a voice inputter can be configured to determine whether a predetermined voice input has been received. Also, the trigger generator 22A generates a trigger when the voice inputter 23 receives the predetermined voice input.

In this way, in addition to effects and advantages similar to those of (1), (2), and (4) in the first embodiment, the following effects and advantages can be achieved according to the present embodiment: (5) The trigger generator 22A generates a trigger due to the voice inputter 23 receiving a voice input. Therefore, the user can store a measured value in the memory 21 at a desired point in time without touching the digital caliper 1. Accordingly, data can be transmitted to the external device 3 without negatively impacting user-friendliness of the digital caliper 1.

### Third Embodiment

FIG. 5 is a block diagram illustrating a digital caliper and an external device according to a third embodiment of the present invention. In the first embodiment, the slider 12 includes the button 12D, and the trigger generator 22 generates a trigger due to the user manipulating the button 12D. In contrast, in the present embodiment, a controller 2B includes a measured value monitor 24 which monitors fluctuations in a measured value over a predetermined interval, and a trigger generator 22B differs in that a trigger is generated due to an absence of fluctuation in the measured value observed by the measured value monitor 24 during the predetermined period of time.

Specifically, the measured value monitor 24 can be configured so as to monitor fluctuations in a measured value by obtaining a measured value using sampling at predetermined intervals (for example, every 100 msec). In addition, the trigger generator 22B can be configured so as to generate a trigger in a case where fluctuations in the measured value are continuously kept within a fixed range until a predetermined period of time elapses (for example, 1 sec).

In this way, in addition to effects and advantages similar to those of (1), (2), and (4) in the first embodiment, the following effects and advantages can be achieved according to the present embodiment: (6) The trigger generator 22B generates a trigger due to an absence of fluctuation in the measured value observed by the measured value monitor 24 during a predetermined period of time. Therefore, the user can store a measured value in the memory 21 simply by performing a normal measurement operation. Accordingly, data can be transmitted to the external device 3 without negatively impacting user-friendliness of the digital caliper 1.

### Fourth Embodiment

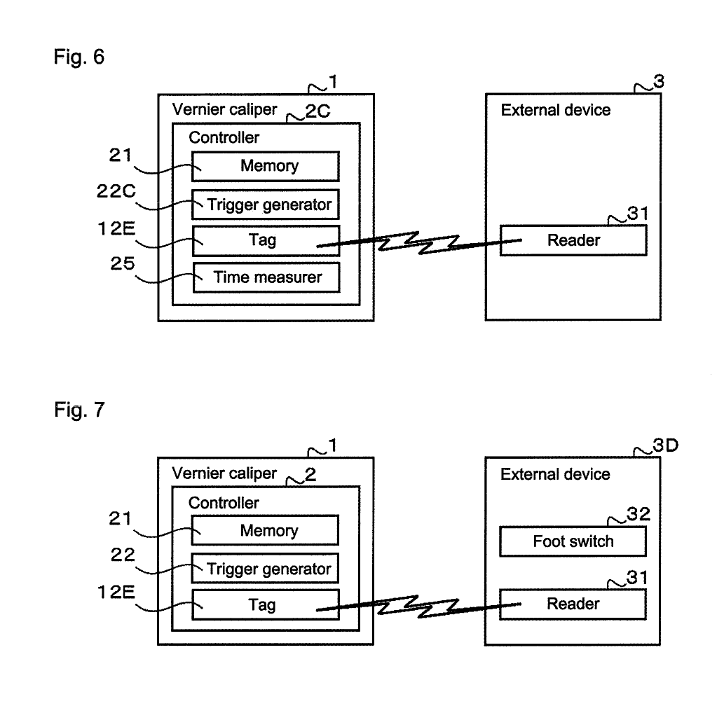

FIG. 6 is a block diagram illustrating a digital caliper and an external device according to a fourth embodiment of the present invention. In the first embodiment, the slider 12 includes the button 12D, and the trigger generator 22 generates a trigger due to the user manipulating the button 12D. In contrast, in the present embodiment, a controller 2C includes a time measurer 25 having a timer or the like measuring time, and a trigger generator 22C differs in that a trigger is generated each time a predetermined period of time elapses (for example, every 5 sec) based on the amount of time measured by the time measurer 25.

In this way, in addition to effects and advantages similar to those of (1), (2), and (4) in the first embodiment, the following effects and advantages can be achieved according to the present embodiment: (7) The trigger generator 22C generates a trigger each time a predetermined period of time elapses. Therefore, the user can store a measured value in the memory 21 automatically simply by performing measurement. Accordingly, data can be transmitted to the external device 3 without negatively impacting user-friendliness of the digital caliper 1.

### Fifth Embodiment

FIG. 7 is a block diagram illustrating a digital caliper and an external device according to a fifth embodiment of the present invention. In the first embodiment, the external device 3 includes the reader 31 and by holding the tag 12E up to the reader 31 of the external device 3, all measured values stored in the memory 21 based on the trigger generated by the trigger generator 22 are transmitted to the external device 3.

In contrast, in the present embodiment, an external device 3D includes the reader 31 and a foot switch 32 turning a power source of the reader 31 ON and OFF, and the tag 12E differs in that data is transmitted to the external device 3D when the tag 12E is in a state capable of transmitting data to the external device 3D. In other words, when the user of the digital caliper 1 manipulates the foot switch 32 to turn ON the power source of the reader 31, so long as the tag 12E is at a distance allowing data to be transmitted to the reader 31 using near field communication, the tag 12E transmits data to the reader 31. Thereby, the user of the digital caliper 1 can transmit measured values to the external device 3D by installing the external device 3D in a vicinity of the digital caliper 1 and operating the foot switch 32 to turn the power source of the reader 31 ON and OFF.

In this way, in addition to effects and advantages similar to those of (1), (3), and (4) in the first embodiment, the following effects and advantages can be achieved according to the present embodiment: (8) The user of the digital caliper 1 can transmit a measured value to the external device 3D by operating the foot switch 32 to turn the power source of the reader 31 ON and OFF. Therefore, the measured value will not change due to an influence of shaking hands or the like. Accordingly, data can be transmitted to the external device 3D without negatively impacting user-friendliness of the digital caliper 1.

In the present embodiment, the user of the digital caliper 1 can transmit a measured value to the external device 3D by operating the foot switch 32 to turn the power source of the reader 31 ON and OFF. Therefore, the digital caliper 1 may also be configured to transmit a current measured value to the external device 3D. In other words, the digital caliper 1 may also be configured so as to not include the button 12D, the memory 21, and the trigger generator 22.

Modifications

Moreover, the present invention is not limited to the above-described embodiments, and includes modifications and improvements within a scope capable of achieving the advantages of the present invention. For example, in each of the above-noted embodiments, the digital caliper 1 exemplifies the measuring device; however, the measuring device may also be a micrometer or the like. In essence, the measuring device of the present invention may be any measuring device having a data transmitter transmitting data to an external device. In each of the above-noted embodiments, the data transmitter transmits data to the external device using RFID. However, data may also be transmitted to the external device using a near field communication technique other than RFID.

In each of the above-noted embodiments, by holding the tag 12E up to the reader 31 of the external device 3, all measured values stored in the memory 21 based on the trigger generated by the trigger generator 22 are transmitted to the external device 3. In other words, in each of the above-noted embodiments, data is transmitted by holding the measuring device up to the external device. In contrast, data may also be transmitted by holding the external device up to the measuring device. The question of which of the measuring device and the external device is held up may be determined according to the size and weight of the measuring device and the external device. Moreover, in a case requiring that a large, heavy measuring device and external device be held up, portability and user-friendliness may also be improved by mounting a tag or reader to a wristband or the like.

In each of the above-noted embodiments, the digital caliper 1 includes the memory 21 and the trigger generators 22, 22A, 22B, and 22C, respectively. However, the digital caliper 1 may also be configured so as to not include these components. For example, a measuring device may be configured so as to obtain a measured value when data is transmitted by a data transmitter, and to transmit the measured value as data to an external device. In essence, the measuring device may be any measuring device having a data transmitter transmitting data to an external device.

In each of the above-noted embodiments, the trigger generator 22 generates a trigger due to the user operating a button; the trigger generator 22A generates a trigger due to the voice inputter 23 receiving voice input; the trigger generator 22B generates a trigger due to an absence of fluctuation in the measured value observed by the measured value monitor 24 during a predetermined period of time; and the trigger generator 22C generates a trigger for each predetermined amount of time elapsed. However, a trigger generator may also generate a trigger at a point in time different from any of these.

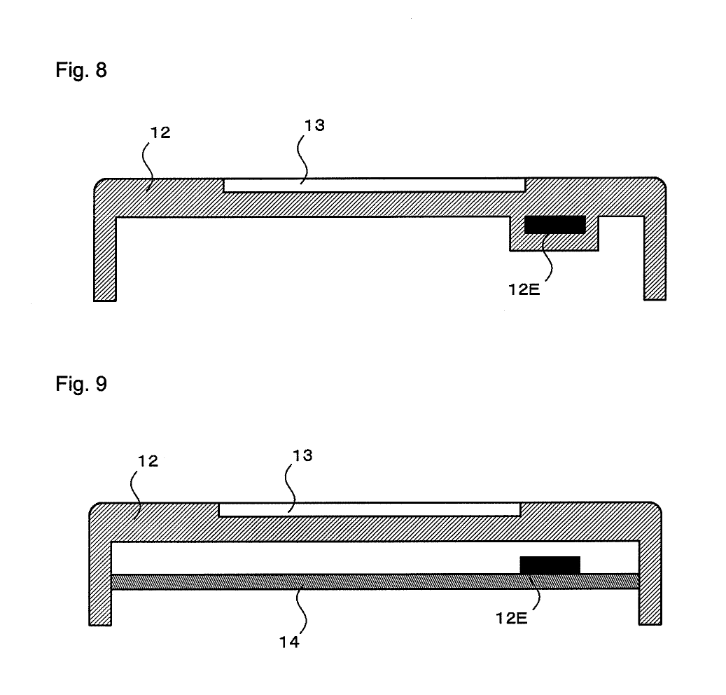

FIG. 8 illustrates a first exemplary tag mounting position. FIG. 9 illustrates a second exemplary tag mounting position. In each of the above-noted embodiments, the tag 12E is mounted to a rear side of the surface to which the display 13 is provided, i.e., between the main scale 11 and the display 13. In contrast, as shown in FIG. 8, the tag 12E may also be embedded in an interior of the slider 12 or, as shown in FIG. 9, may be mounted to a substrate 14 fixated to the interior of the slider 12. In each of the above-noted embodiments, the tag 12E is provided on the interior of the digital caliper 1; however, the tag 12E may also be provided on the exterior of the digital caliper 1.

As noted above, the present invention can be employed with a measuring device, and can be employed particularly favorably with a measuring device transmitting data to an external measuring device.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A measuring device comprising a data transmitter configured to transmit data to an external device using near field communication.

2. The measuring device according to claim 1, further comprising a controller comprising:
the data transmitter,
a memory configured to store at least one measured value measured by the measuring device; and
a trigger generator configured to generate a trigger for when the measured value measured by the measuring device is to be stored in the memory, wherein the data transmitter is configured to transmit to the external device the measured value stored in the memory based on the trigger.

3. The measuring device according to claim 2, further comprising a button exposed to an exterior, wherein the trigger generator is further configured to generate the trigger due to a user operating the button.

4. The measuring device according to claim 2, wherein:
the controller further comprises a voice inputter configured to receive voice input, and
the trigger generator is further configured to generate the trigger due to the voice inputter receiving the voice input.

5. The measuring device according to claim 2, wherein:
the controller further comprises a measured value monitor configured to monitor fluctuations in a measured value over a predetermined interval, and
the trigger generator is further configured to generate the trigger due to an absence of fluctuation in the measured value observed by the measured value monitor during the predetermined period of time.

6. The measuring device according to claim 2, wherein:
the controller further comprises a time measurer configured to measure an amount of time, and
the trigger generator is further configured to generate a trigger for each predetermined amount of time elapsed.

7. The measuring device according to claim 1, wherein the data transmitter is located on an interior of the measuring device.

8. The measuring device according to claim 2, wherein the data transmitter is located on an interior of the measuring device.

9. The measuring device according to claim 3, wherein the data transmitter is located on an interior of the measuring device.

10. The measuring device according to claim 4, wherein the data transmitter is located on an interior of the measuring device.

11. The measuring device according to claim 5, wherein the data transmitter is located on an interior of the measuring device.

12. The measuring device according to claim 6, wherein the data transmitter is located on an interior of the measuring device.

13. The measuring device according to claim 1, wherein when the data transmitter is in a state capable of transmitting data to the external device, the data transmitter transmits data to the external device.

14. The measuring device according to claim 2, wherein when the data transmitter is in a state capable of transmitting data to the external device, the data transmitter transmits data to the external device.

15. The measuring device according to claim 3, wherein when the data transmitter is in a state capable of transmitting data to the external device, the data transmitter transmits data to the external device.

16. The measuring device according to claim 4, wherein when the data transmitter is in a state capable of transmitting data to the external device, the data transmitter transmits data to the external device.

17. The measuring device according to claim 5, wherein when the data transmitter is in a state capable of transmitting data to the external device, the data transmitter transmits data to the external device.

18. The measuring device according to claim 6, wherein when the data transmitter is in a state capable of transmitting data to the external device, the data transmitter transmits data to the external device.

19. The measuring device according to claim 7, wherein when the data transmitter is in a state capable of transmitting data to the external device, the data transmitter transmits data to the external device.

20. The measuring device according to claim 8, wherein when the data transmitter is in a state capable of transmitting data to the external device, the data transmitter transmits data to the external device.

21. The measuring device according to claim 9, wherein when the data transmitter is in a state capable of transmitting data to the external device, the data transmitter transmits data to the external device.

22. The measuring device according to claim 10, wherein when the data transmitter is in a state capable of transmitting data to the external device, the data transmitter transmits data to the external device.

23. The measuring device according to claim 11, wherein when the data transmitter is in a state capable of transmitting data to the external device, the data transmitter transmits data to the external device.

24. The measuring device according to claim 12, wherein when the data transmitter is in a state capable of transmitting data to the external device, the data transmitter transmits data to the external device.
